(19) United States
(12) Patent Application Publication
(10) Pub. No.: US 2025/0310763 A1
(43) Pub. Date: Oct. 2, 2025

(54) Home Network-Triggered Authentication Procedure

(71) Applicant: Apple Inc., CUPERTINO, CA (US)

(72) Inventors: Shu GUO, Beijing (CN); Dawei ZHANG, Saratoga, CA (US); Huarui LIANG, Beijing (CN); Haijing HU, Los Gatos, CA (US)

(21) Appl. No.: 18/864,350

(22) PCT Filed: May 9, 2022
(86) PCT No.: PCT/CN2022/091700

§ 371 Date: Nov. 8, 2024

(51) Int. Cl. H04W 12/06; H04W 12/04

(52) U.S. Cl. CPC H04W 12/06; H04W 12/04

(57) ABSTRACT

Embodiments of the present disclosure relate to HN-triggered authentication procedure. According to embodiments of the present disclosure, an Authentication Server Function (AUSF) determines to trigger an authentication procedure. Then, the AUSF transmits, to an Access and Mobility Management Function (AMF), a request for the authentication procedure. Alternatively or in addition, a home network entity determines to trigger an authentication procedure. Then, the home network entity transmits, towards the AMF, a request for the authentication procedure via the AUSF. Then, the AMF transmits, to user equipment (UE), a message comprising an indication to initiate the authentication procedure. Moreover, the UE initiates the authentication procedure. The home network entity comprises at least one of: a Unified Data Management (UDM) function, an Authentication Credential Repository and Processing Function (ARPF), or a Subscription Identifier De-concealing Function (SIDF).

### TECHNICAL FIELD

Embodiments of the present disclosure generally relate to the field of telecommunications, and in particular, to home network (HN)-triggered authentication procedure.

### BACKGROUND

The 5G System (5GS) supports an authentication procedure triggered by User Equipment (UE) or a visiting network. The visiting network may initiate a Fifth Generation (5G) Authentication and Key Agreement (AKA) based primary authentication and key agreement procedure for a UE in 5G mobility management CONNECTED (5GMM-CONNECTED) mode at any time. But there are some cases requiring a home network to control and trigger the authentication procedure. Thus, among others open issues, how to enable a HN-triggered authentication procedure is still an open issue to be addressed.

### SUMMARY

In general, example embodiments of the present disclosure provide a solution for HN-triggered authentication procedure.

In a first aspect, there is provided a processor of an Authentication Server Function (AUSF). The processor is configured to perform operations comprising determining to trigger an authentication procedure; and transmitting, to an Access and Mobility Management Function (AMF), a request for the authentication procedure.

In a second aspect, there is provided a processor of a home network entity. The processor is configured to perform operations comprising determining to trigger an authentication procedure; and transmitting, towards an Access and Mobility Management Function (AMF), a request for the authentication procedure via an Authentication Server Function (AUSF).

In a third aspect, there is provided a processor of an Access and Mobility Management Function (AMF). The processor is configured to perform operations comprising receiving, from an Authentication Server Function (AUSF), a request for an authentication procedure; and transmitting, to user equipment (UE), a message comprising an indication to initiate the authentication procedure.

In a fourth aspect, there is provided a processor of user equipment (UE). The processor is configured to perform operations comprising receiving, from an Access and Mobility Management Function (AMF), a message comprising an indication to initiate an authentication procedure; and initiating the authentication procedure.

In a fifth aspect, there is provided a processor of a home network entity. The processor is configured to perform operations comprising determining to trigger an authentication procedure; in response to determining to trigger the authentication procedure, generating an authentication vector; and transmitting, to an Authentication Server Function (AUSF), an authentication get response message comprising the authentication vector and an indication indicating that the authentication procedure is triggered by the home network entity.

In a sixth aspect, there is provided a processor of an Authentication Server Function (AUSF). The processor is configured to perform operations comprising receiving, from a home network entity, an authentication get response message comprising an authentication vector and an indication indicating that an authentication procedure is triggered by the home network entity; and determining a current serving network name.

In a seventh aspect, there is provided a processor of an Authentication Server Function (AUSF). The processor is configured to perform operations determining to trigger an authentication procedure; after determining to trigger the authentication procedure, determining a current serving network name; and transmitting, to a home network entity, an authentication get request message comprising the current serving network name.

In an eight aspect, there is provided a processor of a home network entity. The processor is configured to perform operations comprising receiving, from an Authentication Server Function (AUSF), an authentication get request message comprising a current serving network name; determining that an authentication procedure is triggered by the AUSF; in response to determining that the authentication procedure is triggered by the home network, generating an authentication vector; and transmitting, to the AUSF, an authentication get response message comprising the authentication vector and a second indication indicating that the authentication procedure is triggered by the AUSF.

In a ninth aspect, there is provided an Authentication Server Function (AUSF). The AUSF comprises a transceiver and a processor of the first aspect, or the sixth aspect or the seventh aspect. The transceiver is configured to be communicatively coupled to the processor and to communicate with an Access and Mobility Management Function (AMF) and a home network entity.

In a tenth aspect, there is provided a home network entity. The home network entity comprises a transceiver and a processor of the second aspect, or the fifth aspect, or the eighth aspect. The transceiver is configured to be communicatively coupled to the processor and to communicate with an Authentication Server Function (AUSF).

In a eleventh aspect, there is provided an Access and Mobility Management Function (AMF). The AMF comprises a transceiver and a processor of the third aspect. The transceiver is configured to be communicatively coupled to the processor and to communicate with user equipment (UE) and an Authentication Server Function (AUSF).

In a twelfth aspect, there is provided User equipment (UE). The UE comprises a transceiver and a processor of the fourth aspect. The transceiver is configured to be communicatively coupled to the processor and to communicate with user equipment (UE) and an Authentication Server Function (AUSF).

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates a schematic diagram of an example communication environment in which example embodiments of the present disclosure can be implemented;

FIG. 2 illustrates a schematic diagram illustrating a first process of HN-triggered authentication according to some embodiments of the present disclosure;

FIG. 3 illustrates a schematic diagram illustrating a second process of HN-triggered authentication according to some embodiments of the present disclosure;

FIG. 4 illustrates a schematic diagram illustrating a third process of HN-triggered authentication according to some embodiments of the present disclosure;

FIG. 5 illustrates a schematic diagram illustrating a fourth process of HN-triggered authentication according to some embodiments of the present disclosure;

FIG. 6 illustrates a flowchart of an example method of communication implemented at an AUSF in the first process of HN-triggered authentication according to some embodiments of the present disclosure;

FIG. 7 illustrates a flowchart of an example method of communication implemented at a home network entity in the first process of HN-triggered authentication according to some embodiments of the present disclosure;

FIG. 8 illustrates a flowchart of an example method of communication implemented at an Access and Mobility Management Function (AMF) in the first process of HN-triggered authentication according to some embodiments of the present disclosure;

FIG. 9 illustrates a flowchart of an example method of communication implemented at a UE in the first process of HN-triggered authentication according to some embodiments of the present disclosure;

FIG. 10 illustrates a flowchart of an example method of communication implemented at a home network entity in the second process of HN-triggered authentication according to some embodiments of the present disclosure;

FIG. 11 illustrates a flowchart of an example method of communication implemented at an AUSF in the second process of HN-triggered authentication according to some embodiments of the present disclosure;

FIG. 12 illustrates a flowchart of an example method of communication implemented at an AUSF in the third process or the fourth process of HN-triggered authentication according to some embodiments of the present disclosure;

FIG. 13 illustrates a flowchart of an example method of communication implemented at a home network entity in the fourth process of HN-triggered authentication according to some embodiments of the present disclosure; and

FIG. 14 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As mentioned above, the 5GS supports an authentication procedure triggered by the UE or a visiting network. But there are some cases requiring the home network to trigger the authentication procedure. Thus, there is a need to support the HN-triggered authentication procedure. Besides, by now, there is no effective way to enable HN-triggered authentication procedure to facilitate more application scenarios.

Some embodiments of the present disclosure propose a solution for HN-triggered authentication procedure. In this solution, a processor of an AUSF is configured to perform operations. The operations include determining to trigger an authentication procedure. The operations also include transmitting, to an AMF, a request for the authentication procedure. Alternatively or in addition, a processor of a home network entity is configured to perform operations. The operations include determining to trigger an authentication procedure. The operations also include transmitting, towards the AMF, a request for the authentication procedure via the AUSF. Then, a processor of the AMF is configured to transmit, to user equipment (UE), a message comprising an indication to initiate the authentication procedure. Moreover, a processor of UE is configured to initiate the authentication procedure.

Some other embodiments of the present disclosure propose a solution for HN-triggered authentication procedure. In this solution, a processor of a home network entity is configured to perform operations. The operations include determining to trigger an authentication procedure. The operations also include in response to determining to trigger the authentication procedure, generating an authentication vector. The operations further include transmitting, to an AUSF, an authentication get response message comprising the authentication vector and an indication indicating that the authentication procedure is triggered by the home network entity.

Some further embodiments of the present disclosure propose a solution for HN-triggered authentication procedure. In this solution, a processor of an AUSF is configured to perform operations. The operations include determining to trigger an authentication procedure. The operations also include after determining to trigger the authentication procedure, determining a current serving network name. The operations further include transmitting, to a home network entity, an authentication get request message comprising the current SNN.

Some additional embodiments of the present disclosure propose a solution for HN-triggered authentication procedure. In this solution, a processor of a home network entity is configured to perform operations. The operations include receiving, from an AUSF, an authentication get request message comprising a current SNN. The operations also include determining that an authentication procedure is triggered by the AUSF. The operations further include in response to determining that the authentication procedure is triggered by the home network, generating an authentication vector. Moreover, the operations include transmitting, to the AUSF, an authentication get response message comprising the authentication vector and a second indication indicating that the authentication procedure is triggered by the AUSF.

According to embodiments of the present disclosure, the HN can trigger an authentication procedure. In such way, if there is a need for refresh of a key for the AUSF, K_{AUSF} or UE Parameter Update (UPU)/Steering of Roaming (SoR) count wrap around occurs, a HN-trigger authentication procedure can be initiated timely, thereby improving service continuity.

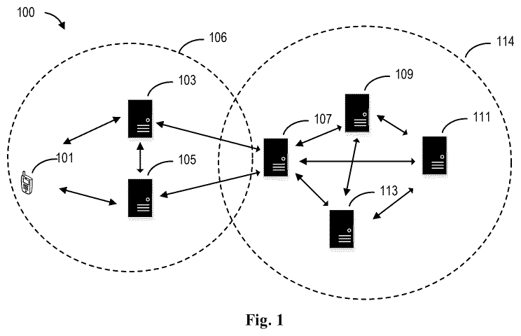

Principle and implementations of the present disclosure will be described in detail below with reference to FIGS. 1-14.

FIG. 1 shows an example communication environment 100 in which embodiments of the present disclosure can be implemented. As shown in FIG. 1, the communication environment 100, which is a part of a communication network, includes UE 101, an AMF 103, and a Security Anchor Function (SEAF) 105 in a serving network 106. The first UE 101 may communicate with the AMF 103 and the SEAF 105 via one or more other devices or functions. The connection between the AMF 103 and the SEAF 105 may be direct or indirect. In some embodiments, the SEAF 105 may be physically integrated into the AMF 103. In this case, the SEAF 105 may communicate with the AMF 103 through internal wiring.

The communication environment 100 further includes an AUSF 107, a Unified Data Management (UDM) function 109, an Authentication Credential Repository and Processing Function (ARPF) 111, and a Subscription Identifier De-concealing Function (SIDF) 113 in a home network 114. The AMF 103 and the SEAF 105 may be connected to the AUSF 107 directly or indirectly via one or more other devices or functions. Similarly, the connections among the AUSF 107, the UDM function 109, the ARPF 111, and the SIDF 113 may be direct or indirect.

For example, the communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the devices or functions is only for the purpose of illustration without suggesting any limitations. The environment 100 may include any other suitable devices, elements or functions adapted for implementing embodiments of the present disclosure.

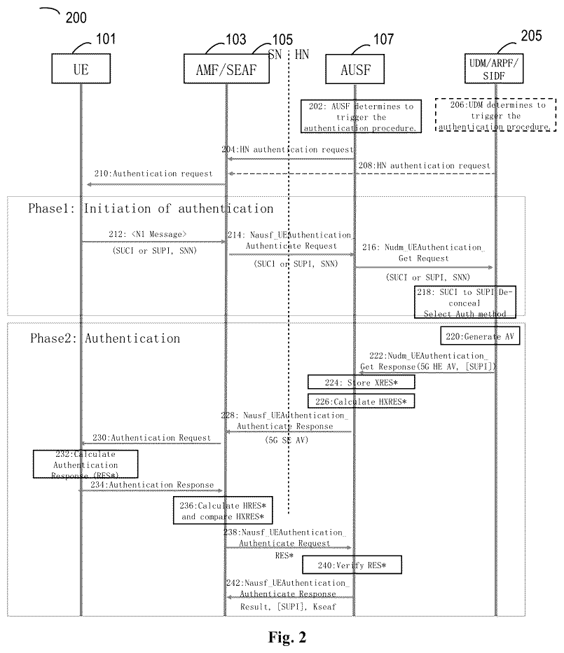

FIG. 2 illustrates a schematic diagram illustrating a first process 200 of HN-triggered authentication according to some embodiments of the present disclosure. For the purpose of discussion, the process 200 will be described with reference to FIG. 1. The process 200 may involve the UE 101, the AMF 103, the SEAF 105, the AUSF 107, the UDM 109, the ARPF 111 and the SIDF 113 as illustrated in FIG. 1. In this case, the SEAF 105 is assumed to be physically integrated into the AMF 103. The steps and the order of the steps in FIG. 2 are merely for illustration, and not for limitation. For convenience, the UDM 109/the ARPF 111/the SIDF 113 is collectively called as a home network entity 205 hereinafter. The home network entity 205 may comprise at least one of the UDM 109, the ARPF 111 or the SIDF 113.

As shown in FIG. 2, the AUSF 107 determines (202) to trigger an authentication procedure. In some embodiments, the AUSF 107 may determine to trigger an authentication procedure, if there is a need for refresh of the K_{AUSF}. Alternatively, or in addition, the AUSF 107 may determine to trigger an authentication procedure, if UPU or SoR count wrap around occurs. Then, the AUSF 107 transmits (204), to the AMF 103, a request for the authentication procedure.

Alternatively, or in addition, the home network entity 205 may determine (206) to trigger an authentication procedure. In some embodiments, the home network entity 205 may determine to trigger an authentication procedure, if there is a need for refresh of the K_{AUSF}. Alternatively, or in addition, the home network entity 205 may determine to trigger an authentication procedure, if UPU or SoR count wrap around occurs. Then, the home network entity 205 may transmits (208), towards the AMF 103, a request for the authentication procedure via the AUSF 107.

Upon receiving the request for the authentication procedure from the AUSF 107, the AMF 103 transmits (210), to the UE 101, a message comprising an indication to initiate the authentication procedure. In the embodiments where the authentication procedure is triggered by the AUSF 107, the indication may indicate that the authentication procedure is triggered by the AUSF 107. In the embodiments where the authentication procedure is triggered by the home network entity 205, that is, at least one of: the UDM function 109, the ARPF 111, or the SIDF113, the indication may indicate that the authentication procedure is triggered by the home network entity 205. For example, the AMF 103 may transmits, to the UE 101, a non-access stratum (NAS) message comprising the indication to initiate the authentication procedure. As an example, the NAS message may be UE configuration update or de-registration procedure with the indication to UE to start registration again.

Accordingly, the UE 101 initiates the authentication procedure. As shown in FIG. 2, 5G Authentication and key agreement (AKA) relates two phrases, referred to as phrase 1 and phrase 2. The phrase 1 performs initiation of the authentication procedure. The UE 101 transmits (212) a N1 message including identifications such as a Subscription Concealed Identifier (SUCI) or a Subscription Permanent Identifier (SUPI) and a SNN to the SEAF 105. Then, the SEAF 105 transmits (214), to the AUSF 107, an authentication request, for example, the authentication request may be a Nausf_UEAuthentication_Authenticate Request message including the SUCI or SUPI and SNN. The AUSF 107 transmits (216) to the home network entity 205 a Nudm_UEAuthentication_Get Request message including the SUCI or SUPI and SNN. Then, the home network entity 205 selects (218) an authentication method.

At phrase 2, for each Nudm_Authenticate_Get Request, the UDM 109/ARPF 111 generates (220) a 5G home environment (HE) authentication vector (AV). For example, the UDM 109/ARPF 111 may then derive a key for the AUSF 107, K_{AUSF} and calculate expected user response XRES*. Finally, the UDM 109/ARPF 111 may create a 5G HE AV from random a random value (RAND), an authentication token (AUTN), the XRES*, and the K_{AUSF}. Then, the UDM 109 returns (222) the 5G HE AV to the AUSF 107 together with an indication that the 5G HE AV is to be used for 5G AKA in a Nudm_UEAuthentication_Get Response message. In case SUCI is included in the Nudm_UEAuthentication_Get Request, the UDM 109 may include the SUPI in the Nudm_UEAuthentication_Get Response.

The AUSF 107 stores (224) the XRES* temporarily together with the received SUCI or SUPI. The AUSF 107 further calculates (226) expected hash of RES, HXRES* from the XRES*. AUSF 107 may further calculate the K_{SEAF} from the K_{AUSF}. The AUSF 107 may then generate a 5G SE AV from the 5G HE AV received from the UDM 109/ARPF 111 by replacing the XRES* with the HXRES* and K_{AUSF} with K_{SEAF} in the 5G HE AV. Then, the AUSF 107 transmits (228) the 5G SE AV (RAND, AUTN, HXRES*) to the SEAF 105 in a Nausf_UEAuthentication_Authenticate Response message.

The SEAF 105 transmits (230) RAND, AUTN to the UE in a NAS message Authentication Request. A Mobile Equipment (ME) of the UE 101 may forward the RAND and AUTN received in NAS message Authentication Request to a Universal Subscriber Identity Module (USIM) of the UE 101. Upon receipt of the RAND and AUTN, the USIM of the UE 101 may verify the freshness of the 5G SE AV by checking whether the AUTN can be accepted. If so, the USIM of the UE 101 computes (232) an authentication response RES. The USIM may return the RES, Cipher Key (CK), Integrity Key (IK) to the ME. The ME of the UE 101 then computes the RES* from the RES. For example, the ME may calculate the K_{AUSF} from CK∥IK. The ME may calculate the K_{SEAF} from the K_{AUSF}. In case of a synchronization failure, the UE 101 may reply with a Sync_failure indication.

Then, the UE 101 transmits (234) RES* to the SEAF 105 in a NAS message Authentication Response. The SEAF 105 computes (236) HRES* from RES*, and the SEAF 105 compares the HRES* with the HXRES*. If they coincide, the SEAF may consider the authentication successful from the serving network point of view. Then, the SEAF 105 transmits (238) RES*, as received from the UE 101, in a Nausf_UEAuthentication_Authenticate Request message to the AUSF 107. When the AUSF 107 receives as authentication confirmation the Nausf_UEAuthentication_Authenticate Request message including a RES*, it may verify whether the AV has expired. If the AV has expired, the AUSF 107 may consider the authentication as unsuccessful from the home network point of view. Upon successful authentication, the AUSF 107 may store the K_{AUSF}. Then, the AUSF 107 verify (240) the received RES* by compare the received RES* with the stored XRES*. If the RES* and the XRES* are equal, the AUSF 107 may consider the authentication as successful from the home network point of view. Then, the AUSF 107 may inform UDM about the authentication result.

Then, the AUSF 107 indicates (242) to the SEAF 105 in the Nausf_UEAuthentication_Authenticate Response message whether the authentication is successful or not from the home network point of view. If the authentication is successful, the K_{SEAF} may be sent to the SEAF 105 in the Nausf_UEAuthentication_Authenticate Response message. Otherwise, if the authentication is successful, the K_{SEAF} received in the Nausf_UEAuthentication_Authenticate Response message may become the anchor key. Then the SEAF 105 may derive a key for the AMF 103, K_{AMF}, from the K_{SEAF}, the Anti-Bidding down Between Architectures (ABBA) parameter and the SUPI. The SEAF 105 may provide a key set identifier in 5G (ngKSI) and the K_{AMF} to the AMF 103.

In this way, if there is a need for the HN to trigger an authentication procedure, the HN-trigger authentication procedure can be initiated timely, thereby improving service continuity.

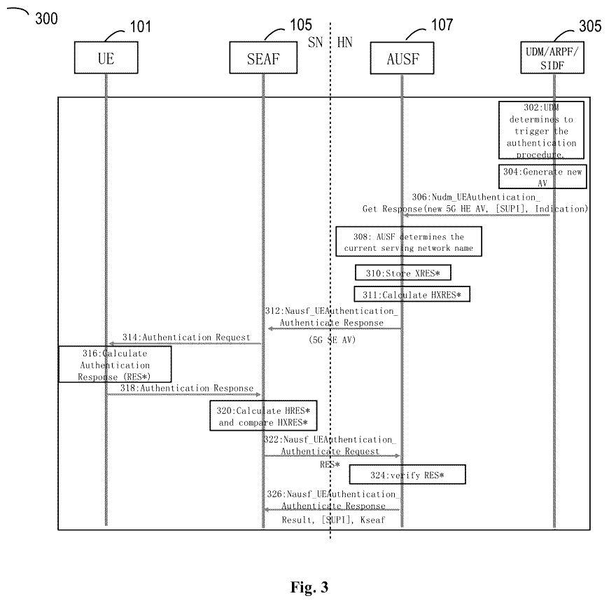

FIG. 3 illustrates a schematic diagram illustrating a second process 300 of HN-triggered authentication according to some embodiments of the present disclosure. For the purpose of discussion, the process 300 will be described with reference to FIG. 1. The process 300 may involve the UE 101, the SEAF 105, the AUSF 107, the UDM 109, the ARPF 111 and the SIDF 113 as illustrated in FIG. 1. The steps and the order of the steps in FIG. 3 are merely for illustration, and not for limitation. For convenience, the UDM 109/the ARPF 111/the SIDF 113 is collectively called as a home network entity 305 hereinafter. The home network entity 305 may comprise at least one of the UDM 109, the ARPF 111 or the SIDF 113. In this case, the phrase 1 is similar to the phrase 1 described above with reference to FIG. 2.

As shown in FIG. 3, the home network entity 305 determines (302) to trigger an authentication procedure. In some embodiments, the home network entity 305 may determine to trigger an authentication procedure, if there is a need for refresh of the K_{AUSF}. Alternatively, or in addition, the home network entity 305 may determine to trigger an authentication procedure, if UPU or SoR count wrap around occurs. Then, Without Nudm_Authenticate_Get Request message, in response to determining to trigger the authentication procedure, the home network entity 305 generates (304) a new 5G HEAV It is to be noted that considering that the phrase 2 has been performed before, the 5G HE AV created at this time may be called as a new 5G HE AV. For example, the UDM 109/ARPF 111 may then derive a new K_{AUSF} and calculate a new XRES*. Finally, UDM 109/ARPF 111 may create the new 5G HE AV from a RAND, an AUTN, the new XRES*, and the new K_{AUSF}.

Then, the home network entity 305 transmits (306), to the AUSF 107, an authentication get response message comprising the 5G E AV and an indication indicating that the authentication procedure is triggered by the home network entity 305. For example, The UDM 109 may then return the new 5G IE AV and the indication to the AUSF 107 together with an indication that the new 5G IE AV is to be used for 5G-AKA in a Nudm_UEAuthentication_Get Response message. In case the SUCI is included in the Nudm_UEAuthentication_Get Request message, the UDM 109 may include the SUPI in the Nudm_UEAuthentication_Get Response message.

Upon reception of the indication indicating that the authentication procedure is triggered by the home network entity 305, the AUSF 107 determines (308) a current SNN. For example, the AUSF 107 may obtain the current SNN from the AMVF 107, or the AUSF 107 may already know the current SNN. It is to be noted that, there is a need for the AUSF 107 to obtain the same K_{SEAF} with the UE 101, as the UE 101 will only use its current SNN to derive the K_{SEAF}. For example, the AUSF 107 may determine the current SNN by requesting the current SNN from the AMF 103 using a Namf_EventExposure service. As an example, the Namf_EventExposure service may be shown in Table 1.

TABLE 1
example of Event Filters for AMF exposure events

| Event ID | Event Filter (List of Parameter Values to Match) |
|---|---|
| Location Report | <Parameter Type = LocationFilter, Value = TAI> |
| UE moving in or out | <Parameter Type = TAI, Value = TAI> |
| of Area of Interest | <Parameter Type = S-NSSAI, Value = S-NSSAI1> |
| | <Parameter Type = NSI ID, Value = NSI ID1> |
| | <Parameter Type = PRA ID, Value = PRA ID value> |
| Access Type | <Parameter Type = AN Type, Value = 3GPP Access”> |
| Location | <Parameter Type = TAI, Value = wildcard> (to report any TAI change) |
| Location | <Parameter Type = TAI Value = abnormal> (to report only when the TAI |
| | deviates from expected values based on Expected UE Moving Trajectory). |
| Reachability Filter | Applicable to the event UE reachability. Value = UE reachability status |
| | change or UE reachable for DL traffic. Absence of this parameter in UE |
| | reachability event request is interpreted as “UE reachability status change”. |
| Total number of | <Parameter Type = TAI, Value = TAI> |
| Transactions | <Parameter Type = S-NSSAI, Value = S-NSSAI1> |
| Number of UEs | <Parameter Type = UE Type, Value = Aerial UE> |
| present in a | <Parameter Type = PDU session status, Value = PDU session established |
| geographical area | for DNN subject to aerial services> |
| Serving network | <Parameter Type = geographical area, |
| name | Value = SN name> |

Then, the AUSF 107 stores (310) the new XRES* temporarily together with the received SUCI or SUPI. The AUSF 107 calculates (311) the HXRES* from the XRES*. Further, the AUSF 107 calculates the K_{SEAF} from the K_{AUSF} based on the current SNN. For example, the AUSF 107 may then generate the new 5G SE AV from the new 5G HE AV received from the UDM 107/ARPF111 by replacing the XRES* with the HXRES* and K_{AUSF} with K_{SEAF} in the new 5G HE AV. Then, the AUSF 107 transmits (312) the new 5G SE AV (RAND, AUTN, HXRES*) to the SEAF 105 in a Nausf_UEAuthentication_Authenticate Response message.

Further, the SEAF 105 transmits (314) new (RAND, AUTN) to the UE 101 in a NAS message Authentication Request message. The ME of the UE 101 may forward the new (RAND, AUTN) received in NAS message Authentication Request to the USIM of the UE 101. Upon receipt of the new (RAND, AUTN), the USIM of the UE 101 may verify the freshness of the new 5G SE AV by checking whether AUTN can be accepted. If so, the USIM of the UE 101 computes (316) a new authentication response RES. The USIM may return the RES, CK, IK to the ME. The ME may then compute the new RES* from the new RES. For example, the ME may calculate the new K_{AUSF} from CK∥IK. The ME may calculate the new K_{SEAF} from the new K_{AUSF}. In case of a synchronization failure, the UE 101 may reply with a Sync_failure indication.

Then, the UE 101 transmits (318) the new RES* to the SEAF 105 in a NAS message Authentication Response. The SEAF 105 computes (320) the HRES* from the new RES*, and the SEAF 105 compares the HRES* with the HXRES*. If they coincide, the SEAF 105 may consider the authentication successful from the serving network point of view. Further, the SEAF 105 transmits (322) the new RES*, as received from the UE 101, in a Nausf_UEAuthentication_Authenticate Request message to the AUSF 107. When the AUSF 107 receives as authentication confirmation the Nausf_UEAuthentication_Authenticate Request message including the RES*, it may verify whether the AV has expired. If the AV has expired, the AUSF 107 may consider the authentication as unsuccessful from the home network point of view. Upon successful authentication, the AUSF 107 may store the K_{AUSF}. Then, the AUSF 107 verify (324) the received RES* by compare the received RES* with the stored XRES*. If the RES* and the XRES* are equal, the AUSF may consider the authentication as successful from the home network point of view. Then, the AUSF 107 may inform the UDM 109 about the authentication result.

Then, the AUSF 107 indicates (326) to the SEAF 105 in the Nausf_UEAuthentication_Authenticate Response message whether the authentication is successful or not from the home network point of view. If the authentication is successful, the K_{SEAF} may be sent to the SEAF 105 in the Nausf_UEAuthentication_Authenticate Response message. Otherwise, if the authentication is successful, the K_{SEAF} received in the Nausf_UEAuthentication_Authenticate Response message may become the anchor key. Then the SEAF 105 may derive the new K_{AMF} from the new K_{SEAF}, the ABBA parameter and the SUPI. The SEAF 105 may provide the ngKSI and the K_{AMF} to the AMF 103.

In this way, if there is a need for the HN to trigger an authentication procedure, the HN-trigger authentication procedure can be initiated timely, thereby improving service continuity.

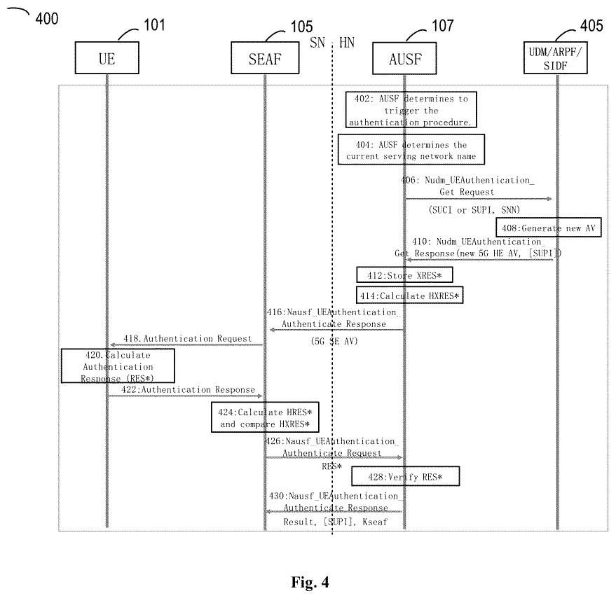

FIG. 4 illustrates a schematic diagram illustrating a third process 400 of HN-triggered authentication according to some embodiments of the present disclosure. For the purpose of discussion, the process 400 will be described with reference to FIG. 1. The process 400 may involve the UE 101, the SEAF 105, the AUSF 107, the UDM 109, the ARPF 111 and the SIDF 113 as illustrated in FIG. 1. The steps and the order of the steps in FIG. 4 are merely for illustration, and not for limitation. For convenience, the UDM 109/the ARPF 111/the SIDF 113 is collectively called as a home network entity 405 hereinafter. The home network entity 405 may comprise at least one of the UDM 109, the ARPF 111 or the SIDF 113. In this case, the phrase 1 is similar to the phrase 1 described above with reference to FIG. 2.

As shown in FIG. 4, the AUSF 107 determines (402) to trigger an authentication procedure. In some embodiments, the AUSF 107 may determine to trigger an authentication procedure, if there is a need for refresh of the K_{AUSF}. Alternatively, or in addition, the AUSF 107 may determine to trigger an authentication procedure, if UPU or SoR count wrap around occurs. Then, after determining to trigger the authentication procedure, the AUSF 107 determines (404) a current SNN. For example, the AUSF 107 may obtain the current SNN from AMF, or the AUSF 107 may already know the current SNN.

Further, the AUSF 107 transmits (406), to the home network entity 405, an authentication get request message comprising the current SNN. For example, the AUSF 107 may transmit, to the UDM 109, a Nudm_UEAuthentication_Get Request message, including the SUCI or SUPI and the current SNN, that is, the updated SNN. Then, without a Nudm_Authenticate_Get Request message, the UDM 109/ARPF 111 generates (408) a new 5G HE AV. For example, the UDM 109/ARPF 111 may then derive a new K_{AUSF} and calculate a new XRES*. Finally, the UDM 109/ARPF 111 may create the new 5G HE AV from a RAND, an AUTN, the new XRES*, and the new K_{AUSF}.

Then, the UDM 109 transmits (410) the new 5G HE AV to the AUSF 107 together with an indication that the new 5G HE AV is to be used for 5G-AKA in a Nudm_UEAuthentication_Get Response message. In case the SUCI is included in the Nudm_UEAuthentication_Get Request message, the UDM 109 may include the SUPI in the Nudm_UEAuthentication_Get Response message. The AUSF 107 stores (412) the new XRES* temporarily together with the received SUCI or SUPI. The AUSF 107 calculates (414) the HXRES* from the XRES*. Further, the AUSF 107 calculates the K_{SEAF} from the K_{AUSF} based on the current SNN. For example, the AUSF 107 may then generate the new 5G SE AV from the new 5G HE AV received from the UDM 109/ARPF 111 by replacing the XRES* with the HXRES* and the K_{AUSF} with the K_{SEAF} in the new 5G HE AV Then, the AUSF 107 transmits (416) the new 5G SE AV (RAND, AUTN, HXRES*) to the SEAF 105 in a Nausf_UEAuthentication_Authenticate Response message.

Further, the SEAF 105 transmits (418) new (RAND, AUTN) to the UE 101 in a NAS message Authentication Request. The ME of the UE 101 may forward the new (RAND, AUTN) received in NAS message Authentication Request to the USIM of the UE 101. Upon receipt of the new (RAND, AUTN), the USIM of the UE 101 may verify the freshness of the new 5G AV by checking whether AUTN can be accepted. If so, the USIM of the UE 101 computes (420) an authentication response RES. The USIM may return the RES, CK, IK to the ME. The ME may then compute the RES* from the RES. For example, the ME may calculate the new K_{AUSF} from CK∥IK. The ME may calculate the new K_{SEAF} from the new K_{AUSF}. In case of a synchronization failure, the UE 101 may reply with a Sync_failure indication.

Then, the UE 101 transmits (422) the new RES* to the SEAF 105 in a NAS message Authentication Response. The SEAF 105 computes (424) the HRES* from the new RES*, and the SEAF 105 compared the HRES* with the HXRES*. If they coincide, the SEAF 105 may consider the authentication successful from the serving network point of view. Further, the SEAF 105s transmits (426) RES*, as received from the UE 101, in a Nausf_UEAuthentication_Authenticate Request message to the AUSF 107. When the AUSF 107 receives as authentication confirmation the Nausf_UEAuthentication_Authenticate Request message including the RES*, it may verify whether the AV has expired. If the AV has expired, the AUSF 107 may consider the authentication as unsuccessful from the home network point of view. Upon successful authentication, the AUSF 107 may store the K_{AUSF}. Then, the AUSF 107 verify (428) the received RES* by compare the received RES* with the stored XRES*. If the RES* and XRES* are equal, the AUSF 107 may consider the authentication as successful from the home network point of view. Then, the AUSF 107 may inform UDM about the authentication result.

Then, the AUSF 107 indicates (430) to the SEAF 105 in the Nausf_UEAuthentication_Authenticate Response message whether the authentication is successful or not from the home network point of view. If the authentication is successful, the K_{SEAF} may be sent to the SEAF 105 in the Nausf_UEAuthentication_Authenticate Response message. Otherwise, if the authentication is successful, the K_{SEAF} received in the Nausf_UEAuthentication_Authenticate Response message may become the anchor key. Then, the SEAF 105 may derive the new K_{AMF} from the new K_{SEAF}, the ABBA parameter and the SUPI. The SEAF may provide the ngKSI and the K_{AMF} to the AMF 103.

In this way, if there is a need for the HN to trigger an authentication procedure, the HN-trigger authentication procedure can be initiated timely, thereby improving service continuity.

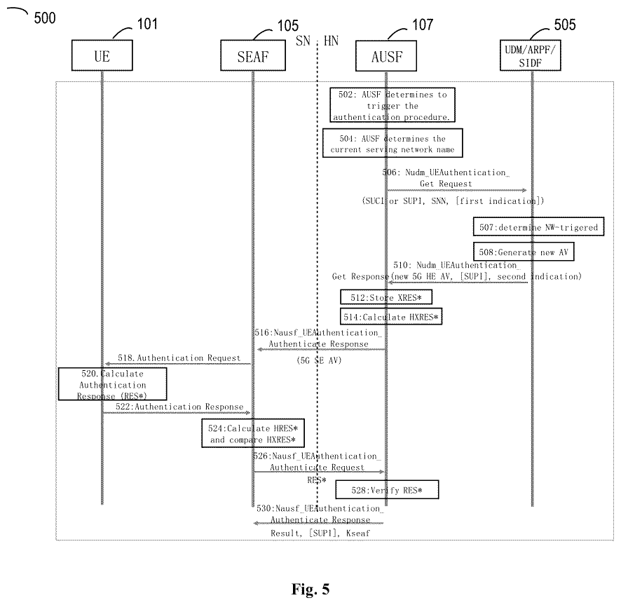

FIG. 5 illustrates a schematic diagram illustrating a fourth process 500 of HN-triggered authentication according to some embodiments of the present disclosure. For the purpose of discussion, the process 500 will be described with reference to FIG. 1. The process 500 may involve the UE 101, the SEAF 105, the AUSF 107, the UDM 109, the ARPF 111 and the SIDF 113 as illustrated in FIG. 1. The steps and the order of the steps in FIG. 5 are merely for illustration, and not for limitation. For convenience, the UDM 109/the ARPF 111/the SIDF 113 is collectively called as a home network entity 505 hereinafter. The home network entity 505 may comprise at least one of the UDM 109, the ARPF 111 or the SIDF 113. In this case, the phrase 1 is similar to the phrase 1 described above with reference to FIG. 2.

As shown in FIG. 5, the AUSF 107 determines (502) to trigger an authentication procedure. In some embodiments, the AUSF 107 may determine to trigger an authentication procedure, if there is a need for refresh of the K_{AUSF}. Alternatively, or in addition, the AUSF 107 may determine to trigger an authentication procedure, if UPU or SoR count wrap around occurs. Then, after determining to trigger the authentication procedure, the AUSF 107 determines (504) a current SNN. For example, the AUSF 107 may obtain the current SNN from AMF, or the AUSF 107 may already know the current SNN.

Further, the AUSF 107 transmits (506), to the home network entity 505, an authentication get request message comprising the current SNN. For example, the AUSF 107 may transmit, to the UDM 109, a Nudm_UEAuthentication_Get Request message, including the SUCI or SUPI and the current SNN, that is, the updated SNN. As an example, the AUSF 107 may transmit, to the home network entity 505, a first indication indicating that the authentication procedure is triggered by the AUSF 107. For example, the indication may be comprised in the authentication get request message. Then, the home network entity 505 determines (507) that the authentication procedure is triggered by the AUSF 107. Further, without a Nudm_Authenticate_Get Request message, in response to determining that the authentication procedure is triggered by the home network, the UDM 109/ARPF 111 generates (508) a new 5G HE AV. For example, the UDM 109/ARPF 111 may then derive a new K_{AUSF} and calculate a new XRES*. Finally, the UDM 109/ARPF 111 may create the new 5G HE AV from a RAND, an AUTN, the new XRES*, and the new K_{AUSF}.

Then, the UDM 109 transmits (510), to the AUSF 107, an authentication get response message comprising the new 5G HE AV and a second indication indicating that the authentication procedure is triggered by the AUSF 107. For example, the UDM 109 may transmit, to the AUSF 107, an authentication get response message comprising the new 5G HE AV and a second indication indicating that the authentication procedure is triggered by the AUSF 107 together with an indication that the new 5G HE AV is to be used for 5G-AKA in a Nudm_UEAuthentication_Get Response message. In case the SUCI is included in the Nudm_UEAuthentication_Get Request message, the UDM 109 may include the SUPI in the Nudm_UEAuthentication_Get Response message. The AUSF 107 stores (512) the new XRES* temporarily together with the received SUCI or SUPI. The AUSF 107 calculates (514) the HXRES* from the XRES*. Further, the AUSF 107 calculates the K_{SEAF} from the K_{AUSF} based on the current SNN. For example, the AUSF 107 may then generate the new 5G SE AV from the new 5G HE AV received from the UDM 109/ARPF 111 by replacing the XRES* with the HXRES* and the K_{AUSF} with the K_{SEAF} in the new 5G HE AV Then, the AUSF 107 transmits (516) the new 5G SE AV (RAND, AUTN, HXRES*) to the SEAF 105 in a Nausf_UEAuthentication_Authenticate Response message.

Further, the SEAF 105 transmits (518) new (RAND, AUTN) to the UE 101 in a NAS message Authentication Request. The ME of the UE 101 may forward the new (RAND, AUTN) received in NAS message Authentication Request to the USIM of the UE 101. Upon receipt of the new (RAND, AUTN), the USIM of the UE 101 may verify the freshness of the new 5G AV by checking whether AUTN can be accepted. If so, the USIM of the UE 101 computes (520) an authentication response RES. The USIM may return the RES, CK, IK to the ME. The ME may then compute the RES* from the RES. For example, the ME may calculate the new K_{AUSF} from CK∥IK. The ME may calculate the new K_{SEAF} from the new K_{AUSF}. In case of a synchronization failure, the UE 101 may reply with a Sync_failure indication.

Then, the UE 101 transmits (522) the new RES* to the SEAF 105 in a NAS message Authentication Response. The SEAF 105 computes (524) the HRES* from the new RES*, and the SEAF 105 compared the HRES* with the HXRES*. If they coincide, the SEAF 105 may consider the authentication successful from the serving network point of view. Further, the SEAF 105s transmits (526) RES*, as received from the UE 101, in a Nausf_UEAuthentication_Authenticate Request message to the AUSF 107. When the AUSF 107 receives as authentication confirmation the Nausf_UEAuthentication_Authenticate Request message including the RES*, it may verify whether the AV has expired. If the AV has expired, the AUSF 107 may consider the authentication as unsuccessful from the home network point of view. Upon successful authentication, the AUSF 107 may store the K_{AUSF}. Then, the AUSF 107 verify (528) the received RES* by compare the received RES* with the stored XRES*. If the RES* and XRES* are equal, the AUSF 107 may consider the authentication as successful from the home network point of view. Then, the AUSF 107 may inform UDM about the authentication result.

Then, the AUSF 107 indicates (530) to the SEAF 105 in the Nausf_UEAuthentication_Authenticate Response message whether the authentication is successful or not from the home network point of view. If the authentication is successful, the K_{SEAF} may be sent to the SEAF 105 in the Nausf_UEAuthentication_Authenticate Response message. Otherwise, if the authentication is successful, the K_{SEAF} received in the Nausf_UEAuthentication_Authenticate Response message may become the anchor key. Then, the SEAF 105 may derive the new K_{AMF} from the new K_{SEAF}, the ABBA parameter and the SUPI. The SEAF may provide the ngKSI and the K_{AMF} to the AMF 103.

In this way, if there is a need for the HN to trigger an authentication procedure, the HN-trigger authentication procedure can be initiated timely, thereby improving service continuity.

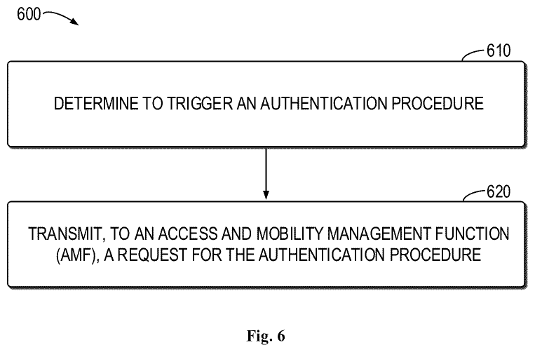

FIG. 6 illustrates a flowchart of an example method 600 of communication implemented at an AUSF in the first process of HN-triggered authentication according to some embodiments of the present disclosure. The method 600 can be implemented at a device, for example, the AUSF 107 as shown in FIG. 1. It is to be understood that the method 600 may include additional blocks not shown and/or may omit some shown blocks, and the scope of the present disclosure is not limited in this regard.

At block 610, the AUSF 107 determines to trigger an authentication procedure. At block 620, the AUSF 107 transmits, to the Access and Mobility Management Function (AMF) 103, a request for the authentication procedure.

In some embodiments, the AUSF 107 may in accordance with a determination that there is a need for refresh of a key for the AUSF, or UE Parameter Update (UPU) or Steering of Roaming (SoR) count wrap around occurs, determine to trigger the authentication procedure.

With the method 600, a HN-trigger authentication procedure can be initiated timely, thereby improving service continuity.

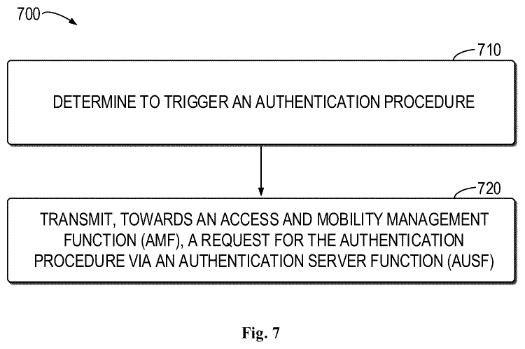

FIG. 7 illustrates a flowchart of an example method 700 of communication implemented at a home network entity in the first process of HN-triggered authentication according to some embodiments of the present disclosure. The method 700 can be implemented at a home network entity, for example, at least one of: the UDM function 109, the ARPF 111, or the SIDF 113 as shown in FIG. 1. It is to be understood that the method 700 may include additional blocks not shown and/or may omit some shown blocks, and the scope of the present disclosure is not limited in this regard.

At block 710, the home network entity determines to trigger an authentication procedure. At block 720, the home network entity transmits towards the Access and Mobility Management Function (AMF) 103, a request for the authentication procedure via the Authentication Server Function (AUSF) 107.

In some embodiments, the home network entity may in accordance with a determination that there is a need for refresh of a key for the AUSF, or UE Parameter Update (UPU) or Steering of Roaming (SoR) count wrap around occurs, determine to trigger the authentication procedure.

In some embodiments, the home network entity may comprise at least one of: a Unified Data Management (UDM) function, an Authentication Credential Repository and Processing Function (ARPF), or a Subscription Identifier De-concealing Function (SIDF).

With the method 700, a HN-trigger authentication procedure can be initiated timely, thereby improving service continuity.

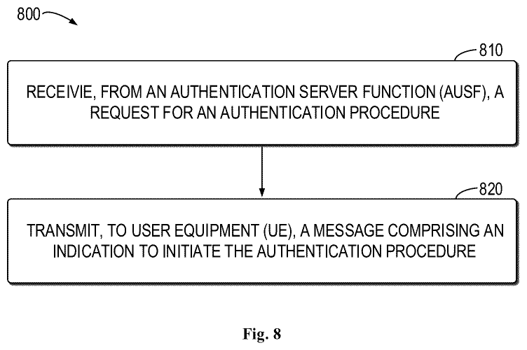

FIG. 8 illustrates a flowchart of an example method 800 of communication implemented at an Access and Mobility Management Function (AMF) in the first process of HN-triggered authentication according to some embodiments of the present disclosure. The method 800 can be implemented at a device, for example, the AMF 103 as shown in FIG. 1. It is to be understood that the method 800 may include additional blocks not shown and/or may omit some shown blocks, and the scope of the present disclosure is not limited in this regard.

At block 810, the AMF 103 receives, from the Authentication Server Function (AUSF) 107, a request for an authentication procedure. At block 820, the AMF 103 transmits, to the user equipment (UE) 101, a message comprising an indication to initiate the authentication procedure.

In some embodiments, the indication may indicate that the authentication procedure is triggered by at least one of: an Authentication Server Function (AUSF), a Unified Data Management (UDM) function, an Authentication Credential Repository and Processing Function (ARPF), or a Subscription Identifier De-concealing Function (SIDF).

In some embodiments, the message may be a non-access stratum (NAS) message.

With the method 800, a HN-trigger authentication procedure can be initiated timely, thereby improving service continuity.

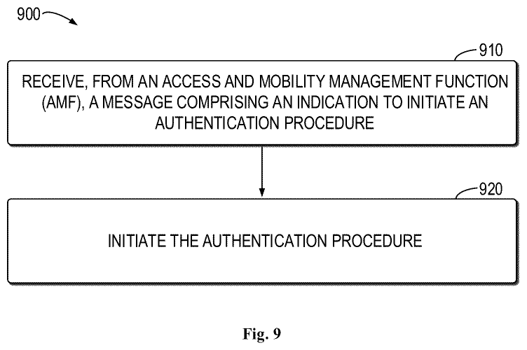

FIG. 9 illustrates a flowchart of an example method 900 of communication implemented at a UE in the first process of HN-triggered authentication according to some embodiments of the present disclosure. The method 900 can be implemented at a device, for example, the UE 101 as shown in FIG. 1. It is to be understood that the method 900 may include additional blocks not shown and/or may omit some shown blocks, and the scope of the present disclosure is not limited in this regard.

At block 910, the UE 101 receives, from the Access and Mobility Management Function (AMF) 103, a message comprising an indication to initiate an authentication procedure. At block 920, the UE 101 initiates the authentication procedure.

In some embodiments, the indication may indicate that the authentication procedure is triggered by at least one of: an Authentication Server Function (AUSF), a Unified Data Management (UDM) function, an Authentication Credential Repository and Processing Function (ARPF), or a Subscription Identifier De-concealing Function (SIDF).

In some embodiments, the message may be a non-access stratum (NAS) message.

With the method 900, a HN-trigger authentication procedure can be initiated timely, thereby improving service continuity.

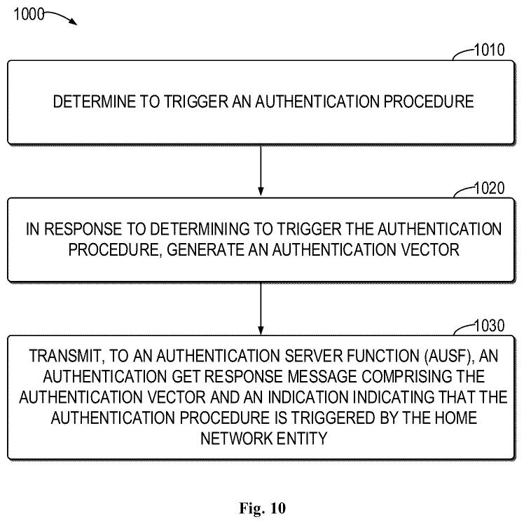

FIG. 10 illustrates a flowchart of an example method 1000 of communication implemented at a home network entity in the second process of HN-triggered authentication according to some embodiments of the present disclosure. The method 1000 can be implemented at a home network entity, for example, at least one of: the UDM function 109, the ARPF 111, or the SIDF 113 as shown in FIG. 1. It is to be understood that the method 1000 may include additional blocks not shown and/or may omit some shown blocks, and the scope of the present disclosure is not limited in this regard.

At block 1010, the home network entity determines to trigger an authentication procedure. At block 1020, in response to determining to trigger the authentication procedure, the home network entity generates an authentication vector. At block 1030, the home network entity transmits, to the Authentication Server Function (AUSF) 107, an authentication get response message comprising the authentication vector and an indication indicating that the authentication procedure is triggered by the home network entity.

In some embodiments, the home network entity may in accordance with a determination that there is a need for refresh of a key for the AUSF, or UE Parameter Update (UPU) or Steering of Roaming (SoR) count wrap around occurs, determine to trigger the authentication procedure.

In some embodiments, the home network entity may comprise at least one of: a Unified Data Management (UDM) function, an Authentication Credential Repository and Processing Function (ARPF), or a Subscription Identifier De-concealing Function (SIDF).

With the method 1000, a HN-trigger authentication procedure can be initiated timely, thereby improving service continuity.

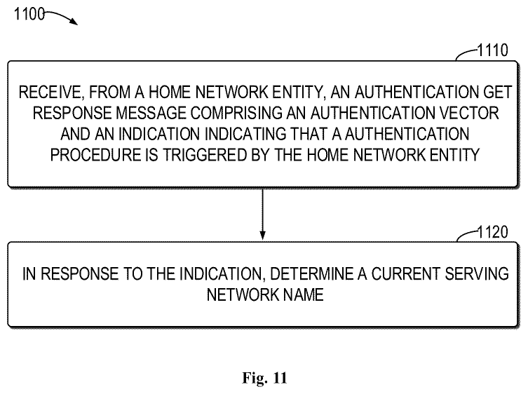

FIG. 11 illustrates a flowchart of an example method 1100 of communication implemented at an AUSF in the second process of HN-triggered authentication according to some embodiments of the present disclosure. The method 1100 can be implemented at a device, for example, the AUSF 107 as shown in FIG. 1. It is to be understood that the method 1100 may include additional blocks not shown and/or may omit some shown blocks, and the scope of the present disclosure is not limited in this regard.

At block 1110, the AUSF 107 receives, from a home network entity, an authentication get response message comprising an authentication vector and an indication indicating that an authentication procedure is triggered by the home network entity. At block 1120, the AUSF 107 in response to the indication, determines a current serving network name.

In some embodiments, the AUSF 107 may obtain the current serving network name from an Access and Mobility Management Function (AMF).

In some embodiments, the home network entity may comprise at least one of: a Unified Data Management (UDM) function, an Authentication Credential Repository and Processing Function (ARPF), or a Subscription Identifier De-concealing Function (SIDF).

With the method 1100, a HN-trigger authentication procedure can be initiated timely, thereby improving service continuity.

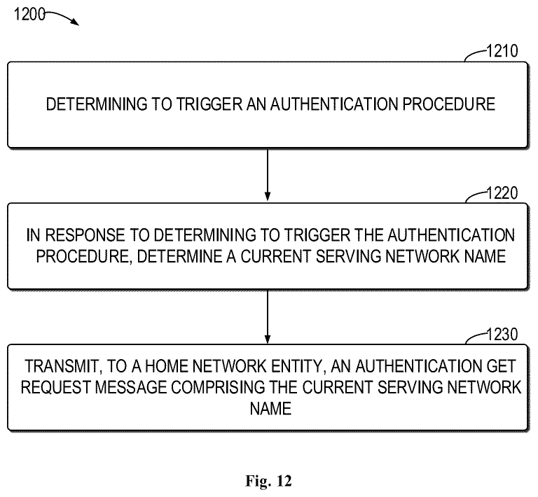

FIG. 12 illustrates a flowchart of an example method 1200 of communication implemented at an AUSF in the third process or the fourth process of HN-triggered authentication according to some embodiments of the present disclosure. The method 1200 can be implemented at a device, for example, the AUSF 107 as shown in FIG. 1. It is to be understood that the method 1200 may include additional blocks not shown and/or may omit some shown blocks, and the scope of the present disclosure is not limited in this regard.

At block 1210, the AUSF 107 determines to trigger an authentication procedure. At block 1220, after determining to trigger the authentication procedure, the AUSF 107 determines a current serving network name. At block 1230, the AUSF 107 transmits, to a home network entity, an authentication get request message comprising the current serving network name.

In some embodiments, the AUSF 107 may obtain the current serving network name from an Access and Mobility Management Function (AMF).

In some embodiments, the AUSF 107 may in accordance with a determination that there is a need for refresh of a key for the AUSF, or UE Parameter Update (UPU) or Steering of Roaming (SoR) count wrap around occurs, determine to trigger the authentication procedure.

In some embodiments, the AUSF 107 may transmit, to the home network entity, a first indication indicating that the authentication procedure is triggered by the AUSF.

In some embodiments, the indication may be comprised in the authentication get request message.

In some embodiments, the AUSF 107 may receive from the home network entity, an authentication get response message comprising a authentication vector and a second indication indicating that the authentication procedure is triggered by the AUSF.

In some embodiments, the home network entity may comprise at least one of: a Unified Data Management (UDM) function, an Authentication Credential Repository and Processing Function (ARPF), or a Subscription Identifier De-concealing Function (SIDF).

With the method 1200, a HN-trigger authentication procedure can be initiated timely, thereby improving service continuity.

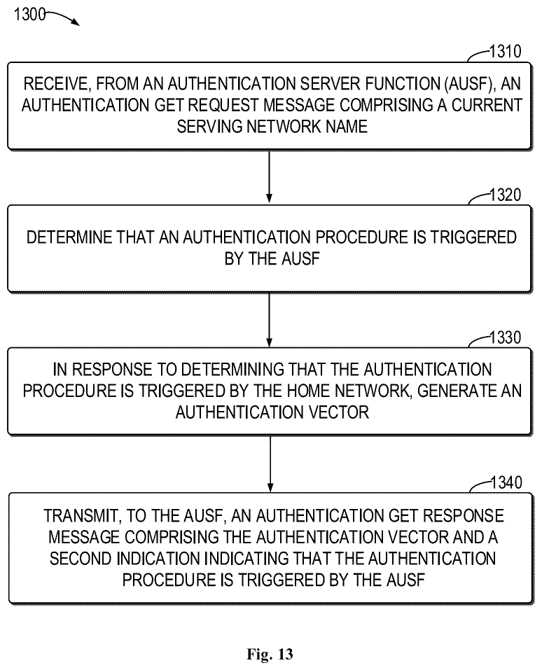

FIG. 13 illustrates a flowchart of an example method 1300 of communication implemented at a home network entity in the fourth process of HN-triggered authentication according to some embodiments of the present disclosure. The method 1300 can be implemented at a home network entity, for example, at least one of: the UDM function 109, the ARPF 111, or the SIDF 113 as shown in FIG. 1. It is to be understood that the method 1300 may include additional blocks not shown and/or may omit some shown blocks, and the scope of the present disclosure is not limited in this regard.

At block 1310, the home network entity receives, from the Authentication Server Function (AUSF) 107, an authentication get request message comprising a current serving network name. At block 1320, the home network entity determines that an authentication procedure is triggered by the AUSF 107. At block 1330, the home network entity in response to determining that the authentication procedure is triggered by the home network, generate an authentication vector. At block 1340, the home network entity transmitting, to the AUSF 107, an authentication get response message comprising the authentication vector and a second indication indicating that the authentication procedure is triggered by the AUSF.

In some embodiments, the home network entity may receive, from the AUSF 107, a first indication indicating that the authentication procedure is triggered by the home network.

In some embodiments, the first indication may be comprised in the authentication get request message.

In some embodiments, the home network entity may comprise at least one of: a Unified Data Management (UDM) function, an Authentication Credential Repository and Processing Function (ARPF), or a Subscription Identifier De-concealing Function (SIDF).

With the method 1300, a HN-trigger authentication procedure can be initiated timely, thereby improving service continuity.

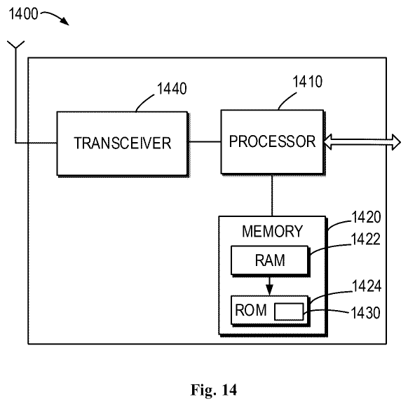

FIG. 14 is a simplified block diagram of a device 1400 that is suitable for implementing embodiments of the present disclosure. For example, the UE 101, the AMF 103, the SEAF 105, the AUSF 107, the UDM 109, the ARPF 111 and the SIDF 113 can be implemented by the device 1400. As shown, the device 1400 includes a processor 1410, a memory 1420 coupled to the processor 1410, and a transceiver 1440 coupled to the processor 1410.

The transceiver 1440 is for bidirectional communications. The transceiver 1440 is coupled to at least one antenna to facilitate communication. The transceiver 1440 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1422 and other volatile memories that will not last in the power-down duration.

A computer program 1430 includes computer executable instructions that are executed by the associated processor 1410. The program 1430 may be stored in the ROM 1424. The processor 1410 may perform any suitable actions and processing by loading the program 1430 into the RAM 1422.

The embodiments of the present disclosure may be implemented by means of the program 1430 so that the device 1400 may perform any process of the disclosure as discussed with reference to FIGS. 2-5. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out any of the methods 600 to 1300 as described above with reference to FIGS. 6 to 13.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a processor of an Authentication Server Function (AUSF) is configured to perform operations comprising: determining to trigger an authentication procedure; and transmitting, to an Access and Mobility Management Function (AMF), a request for the authentication procedure.

In some embodiments, determining to trigger the authentication procedure comprises: in accordance with a determination that there is a need for refresh of a key for the AUSF, or UE Parameter Update (UPU) or Steering of Roaming (SoR) count wrap around occurs, determining to trigger the authentication procedure.

In some aspects, a processor of a home network entity is configured to perform operations comprising: determining to trigger an authentication procedure; and transmitting, towards an Access and Mobility Management Function (AMF), a request for the authentication procedure via an Authentication Server Function (AUSF).

In some embodiments, determining to trigger the authentication procedure comprises: in accordance with a determination that there is a need for refresh of a key for the AUSF, or UE Parameter Update (UPU) or Steering of Roaming (SoR) count wrap around occurs, determining to trigger the authentication procedure.

In some embodiments, the home network entity comprises at least one of: a Unified Data Management (UDM) function, an Authentication Credential Repository and Processing Function (ARPF), or a Subscription Identifier De-concealing Function (SIDF).

In some aspects, a processor of an Access and Mobility Management Function (AMF) is configured to perform operations comprising: receiving, from an Authentication Server Function (AUSF), a request for an authentication procedure; and transmitting, to user equipment (UE), a message comprising an indication to initiate the authentication procedure.

In some embodiments, the indication indicates that the authentication procedure is triggered by at least one of: an Authentication Server Function (AUSF), a Unified Data Management (UDM) function, an Authentication Credential Repository and Processing Function (ARPF), or a Subscription Identifier De-concealing Function (SIDF).

In some embodiments, the message is a non-access stratum (NAS) message.

In some aspects, a processor of user equipment (UE) is configured to perform operations comprising: receiving, from an Access and Mobility Management Function (AMF), a message comprising an indication to initiate an authentication procedure; and initiating the authentication procedure.

In some embodiments, the indication indicates that the authentication procedure is triggered by at least one of: an Authentication Server Function (AUSF), a Unified Data Management (UDM) function, an Authentication Credential Repository and Processing Function (ARPF), or a Subscription Identifier De-concealing Function (SIDF).

In some embodiments, the message is a non-access stratum (NAS) message.

In some aspects, a processor of a home network entity is configured to perform operations comprising: determining to trigger an authentication procedure; in response to determining to trigger the authentication procedure, generating an authentication vector; and transmitting, to an Authentication Server Function (AUSF), an authentication get response message comprising the authentication vector and an indication indicating that the authentication procedure is triggered by the home network entity.

In some embodiments, determining to trigger the authentication procedure comprises: in accordance with a determination that there is a need for refresh of a key for the AUSF, or UE Parameter Update (UPU) or Steering of Roaming (SoR) count wrap around occurs, determining to trigger the authentication procedure.

In some embodiments, the home network entity comprises at least one of: a Unified Data Management (UDM) function, an Authentication Credential Repository and Processing Function (ARPF), or a Subscription Identifier De-concealing Function (SIDF).

In some aspects, a processor of an Authentication Server Function (AUSF) is configured to perform operations comprising: receiving, from a home network entity, an authentication get response message comprising an authentication vector and an indication indicating that a authentication procedure is triggered by the home network entity; and in response to the indication, determining a current serving network name.

In some embodiments, determining the current serving network name comprises: obtaining the current serving network name from an Access and Mobility Management Function (AMF).

In some embodiments, the home network entity comprises at least one of: a Unified Data Management (UDM) function, an Authentication Credential Repository and Processing Function (ARPF), or a Subscription Identifier De-concealing Function (SIDF).

In some aspects, a processor of an Authentication Server Function (AUSF) is configured to perform operations comprising: determining to trigger an authentication procedure; after determining to trigger the authentication procedure, determining a current serving network name; and transmitting, to a home network entity, an authentication get request message comprising the current serving network name.

In some embodiments, determining the current serving network name comprises: obtaining the current serving network name from an Access and Mobility Management Function (AMF).

In some embodiments, determining to trigger the authentication procedure comprises: in accordance with a determination that there is a need for refresh of a key for the AUSF, or UE Parameter Update (UPU) or Steering of Roaming (SoR) count wrap around occurs, determining to trigger the authentication procedure.

In some embodiments, the operations further comprise: transmitting, to the home network entity, a first indication indicating that the authentication procedure is triggered by the AUSF.

In some embodiments, the indication is comprised in the authentication get request message.

In some embodiments, the operations further comprise: receiving from the home network entity, an authentication get response message comprising a authentication vector and a second indication indicating that the authentication procedure is triggered by the AUSF.

In some embodiments, the home network entity comprises at least one of: a Unified Data Management (UDM) function, an Authentication Credential Repository and Processing Function (ARPF), or a Subscription Identifier De-concealing Function (SIDF).

In some aspects, a processor of a home network entity is configured to perform operations comprising: receiving, from an Authentication Server Function (AUSF), an authentication get request message comprising a current serving network name; determining that an authentication procedure is triggered by the AUSF; in response to determining that the authentication procedure is triggered by the home network, generating an authentication vector; and transmitting, to the AUSF, an authentication get response message comprising the authentication vector and a second indication indicating that the authentication procedure is triggered by the AUSF.

In some embodiments, the operations further comprises: receiving, from the AUSF, a first indication indicating that the authentication procedure is triggered by the home network.

In some embodiments, the first indication is comprised in the authentication get request message.

In some embodiments, the home network entity comprises at least one of: a Unified Data Management (UDM) function, an Authentication Credential Repository and Processing Function (ARPF), or a Subscription Identifier De-concealing Function (SIDF).

In some aspects, an Authentication Server Function (AUSF) comprises: a processor configured to perform operations according to some example embodiments of the present disclosure, and a transceiver communicatively coupled to the processor and configured to communicate with an Access and Mobility Management Function (AMF) and a home network entity.

In some aspects, a home network entity, comprising: a processor configured to perform operations according to some example embodiments of the present disclosure, and a transceiver communicatively coupled to the processor and configured to communicate with an Authentication Server Function (AUSF).

In some aspects, an Access and Mobility Management Function (AMF), comprising: a processor configured to perform operations according to some example embodiments of the present disclosure, and a transceiver communicatively coupled to the processor and configured to communicate with user equipment (UE) and an Authentication Server Function (AUSF).

In some aspects, User equipment (UE), comprising: a processor configured to perform operations according to some example embodiments of the present disclosure, and a transceiver communicatively coupled to the processor and configured to communicate with an Access and Mobility Management Function (AMF).

1. A processor of an Authentication Server Function (AUSF) configured to perform operations comprising:
determining to trigger an authentication procedure; and
transmitting, to an Access and Mobility Management Function (AMF), a request for the authentication procedure.

2. The processor of claim 1, wherein determining to trigger the authentication procedure comprises:
in accordance with a determination that there is a need for refresh of a key for the AUSF, or UE Parameter Update (UPU) or Steering of Roaming (SoR) count wrap around occurs, determining to trigger the authentication procedure.

3. A processor of a home network entity configured to perform operations comprising:
determining to trigger an authentication procedure; and
transmitting, towards an Access and Mobility Management Function (AMF), a request for the authentication procedure via an Authentication Server Function (AUSF).

4. The processor of claim 3, wherein determining to trigger the authentication procedure comprises:
in accordance with a determination that there is a need for refresh of a key for the AUSF, or UE Parameter Update (UPU) or Steering of Roaming (SoR) count wrap around occurs, determining to trigger the authentication procedure.

5. The processor of claim 3, wherein the home network entity comprises at least one of: a Unified Data Management (UDM) function, an Authentication Credential Repository and Processing Function (ARPF), or a Subscription Identifier De-concealing Function (SIDF).

6-8. (canceled)

9. A processor of user equipment (UE) configured to perform operations comprising:
receiving, from an Access and Mobility Management Function (AMF), a message comprising an indication to initiate an authentication procedure; and
initiating the authentication procedure.

10. The processor of claim 9, wherein the indication indicates that the authentication procedure is triggered by at least one of: an Authentication Server Function (AUSF), a Unified Data Management (UDM) function, an Authentication Credential Repository and Processing Function (ARPF), or a Subscription Identifier De-concealing Function (SIDF).

11. The processor of claim 9, wherein the message is a non-access stratum (NAS) message.

12-32. (canceled)
